(19) United States
(12) Patent Application Publication
(10) Pub. No.: US 2007/0150400 A1
(43) Pub. Date: Jun. 28, 2007

(54) Transacting system and method for three-way trading

(76) Inventors: Kung-Chieh Cheng, Shenzhen (CN); Hong-Qun Liu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,327

(22) Filed: Jul. 27, 2006

(30) Foreign Application Priority Data
Dec. 2, 2005 (CN) 200510102002.2

(51) Int. Cl. G06Q 40/00

(52) U.S. Cl. 705/37

(57) ABSTRACT

A transacting system is used for processing information in a three-way trading. The transacting system includes a first terminal for loading order notices into the transacting system, a second terminal for loading production lists and shipping notices into the transacting system, a third terminal for generating delivery confirmation receipts and return merchandise authorizes into the transacting system, and a server being connected to the three terminals via networks. The server includes an ordering module for receiving the order notices and generating order lists, a shipping module for generating shipping notices, and an invoice module for receiving the delivery confirmation receipts and generating invoices according to the order notices and the shipping notices. A transacting method used for transacting in the three-way trading is also disclosed.

### FIELD OF THE INVENTION

The present invention generally relates to a transacting system and a transacting method, and more particularly to a transacting system and a transacting method configured for processing information in a three-way trading.

### DESCRIPTION OF RELATED ART

In today's global economy, trades involving multiple parities are common. A three-way trading concerns three enterprises. Generally, a buyer orders an amount of products from a buying/selling agent who orders the same products from a seller. A delivery of goods would involve the seller transporting the products to the buying/selling agent who in turns transports the products to the buyer. A derivative of delivery of goods also exists if the buyer and seller are located nearby, such that the seller would directly deliver the goods to the buyer without going through the buying/selling agent.

The derivative of transportation of goods is widely used between a company group and other enterprises. The company group generally includes many subsidiaries. If both the aforementioned buyer and the seller in the three-way trading are the subsidiaries of the company group, it is preferable to transport the products directly from the seller directly to the buyer, thus, reducing time and cost.

In the three-way trading, a transacting system is used to record, transmit, and confirm information, such as order notices, shipping notices, and return merchandise authorizes (RMAs) etc. A conventional transacting system for the three-way trading is based on a general shipment system, which is used to process information between the buying party and the selling party. However, one party (the agent) is excluded out of the transacting system.

Therefore, a transacting system and a transacting method for processing information in a three-way trading are needed in the industry to address the aforementioned deficiencies and inadequacies.

### SUMMARY OF THE INVENTION

A transacting system is used for processing information in a three-way trading. The transacting system includes a first terminal for loading order notices into the transacting system, a second terminal for loading production lists and shipping notices into the transacting system, a third terminal for generating delivery confirmation receipts and return merchandise authorizes into the transacting system, and a server being connected to the three terminals via networks. The server includes an ordering module for receiving the order notices and generating order lists, a shipping module for generating shipping notices, and an invoice module for receiving the delivery confirmation receipts and generating invoices according to the order notices and the shipping notices. A transacting method used for transacting in the three-way trading is also disclosed.

Other systems, methods, features, and advantages of the present transacting system and method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present transacting system and method can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is a connection diagram of a transacting system for a three-way trading in accordance with an exemplary embodiment, the transacting system including a server;

FIG. 2 is a block diagram of the server of FIG. 1;

FIG. 3 is a process flow diagram of how a transacting method is implemented in the three-way trading in accordance with an exemplary embodiment;

### DETAILED DESCRIPTION OF THE INVENTION

Reference will now be made to the drawings to describe a preferred embodiment of the present transacting system and a preferred embodiment of the present transacting method.

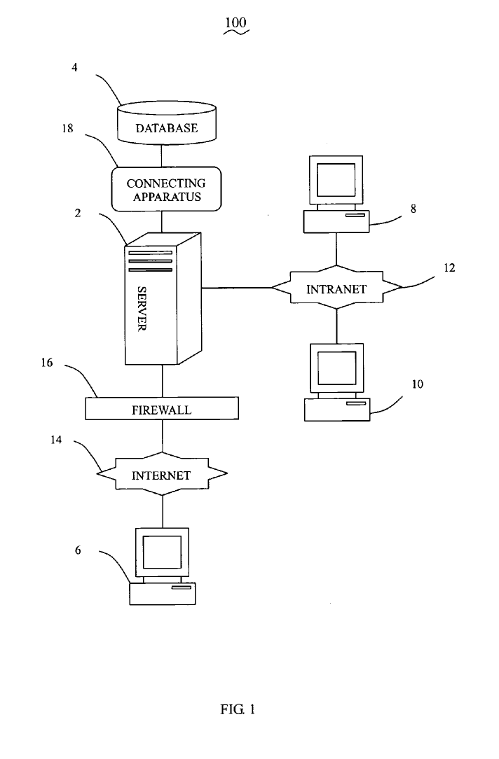

Referring to FIG. 1, a transacting system 100 for processing information in a three-way trading includes a server 2, a database 4, a first terminal 6, a second terminal 8, and a third terminal 10. The server 2 is used for receiving and generating information. The database 4 is connected to the server 2 by a connecting apparatus 18 and is used for storing information. The first terminal 6 is connected to the server 2 by an internet 14 and is used for loading order notices into the server 2. The order notices include order information such as goods names, client names, order quantity, and so on. The second terminal 8 is connected to the server 2 by an intranet 12 and is used for loading production lists into the server 2. The production lists include actual production information such as per day actual production quantity, production dates, and so on. The third terminal 10 is connected to the server 2 by the intranet 12 and is used for generating delivery confirmation receipts and loading return merchandise authorizes into the server 2. The delivery confirmation receipts include information for confirmation merchandise delivery. The return merchandise authorizes include information such as returned goods names, returned quantity, and so on. Furthermore, a firewall 16 is set between the server 2 and the internet 14 to protect the server 2 against unauthorized accesses.

The second terminal 8 and the third terminal 10 can be terminals within a same company group (not shown). The connecting apparatus 18 can be an open database connectivity (ODBC) in this embodiment, and can also be a java database connectivity (JDBC) in another embodiment.

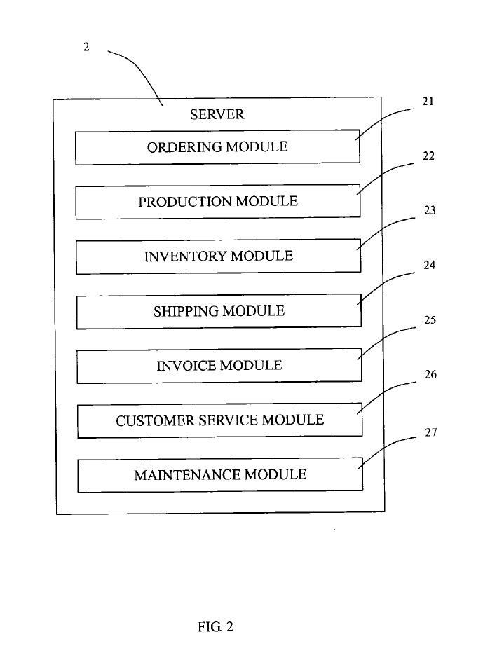

Referring to FIG. 2, the server 2 includes an ordering module 21, a production module 22, an inventory module 23, a shipping module 24, an invoice module 25, a customer service module 26, and a maintenance module 27. The ordering module 21 is used for receiving the order notices and generating order lists according to the order notices. The order lists are in a predetermined format in the database 4. The production module 22 is used for generating production schedules. The production schedules include production planning information such as per day planning production quantity and total production quantity. The inventory module 23 is used for generating inventory lists. The inventory lists include some warehouse stock information such as in-stock quantity. The shipping module 24 is used for judging whether the in-stock quantity are greater than or equal to the order quantity, and generating shipping notices if the in-stock quantity is greater than the order quantity. The shipping notices include shipping information such as shipping quantity, shipping dates, and shipping destinations. The invoice module 25 is used for receiving the delivery confirmation receipts and generating invoices according to the order notices and the shipping notices. The invoices include transaction information such as total quantity, goods values, transport costs, taxes, sum values, and so on. The customer service module 26 is used for receiving the return merchandise authorizes (RMAs) and generating return lists according to the RMAs. The maintenance module 27 is used for searching, updating information in the database 4, and adding information to and deleting information from the database 4.

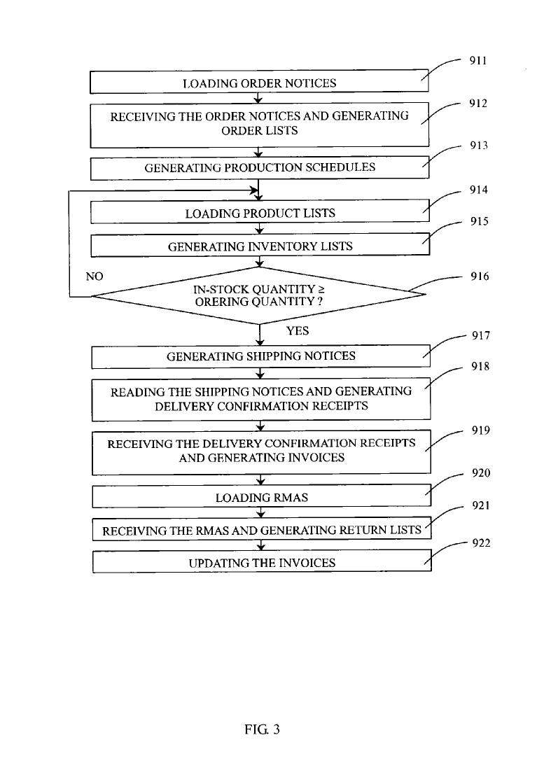

Referring to FIG. 3, a process flow diagram in accordance with an exemplary embodiment illustrates a procedure of a transacting method for processing transaction information in the three-way trading. The procedure includes the following steps.

The first terminal 6 loads the order notice into the server 2. The order notices include goods names, order quantity, client names, order dates, and shipping dates (step 911).

The ordering module 21 receives the order notice and generates order lists according to the order notices. The order lists include goods names, order quantity, client names, order dates, and shipping dates (step 912).

The production module 22 generates production schedules according to the order lists. The production schedules include goods names, client names, per day planning production quantity, total production quantity, and shipping dates (step 913).

The second terminal 8 loads production lists into the server 2. The production lists include goods names, client names, per day actual production quantity, and production dates (step 914).

The inventory module 23 receives the production lists and generates inventory lists. The inventory lists include goods names, client names, in-stock quantity, and production dates (step 915).

The shipping module 24 judges whether the in-stock quantity is smaller than the order quantity. If the in-stock quantity is smaller than the order quantity, the procedure goes back to the step 914 (step 916). If the in-stock quantity is not smaller than the order quantity, the shipping module 24 generates shipping notices. The shipping notices include goods names, client names, shipping quantity, shipping dates, and shipping destinations (step 917).

The third terminal 10 reads the shipping notices and generates delivery confirmation receipts (step 918).

The invoice module 25 receives the delivery confirmation receipts and generates invoices according to the order notices and the shipping notices. The invoices include goods names, total quantity, shipping dates, client names, goods values, transport costs, taxes, and sum values (step 919).

The third terminal 10 loads RMAs into the server 2. The RMAs include return goods names, return causes, return values, and return dates (step 920).

The customer service module 26 receives the RMAs and generates return lists according to the RMAs. The return lists record return goods names, return causes, return values, and return dates (step 921).

The maintenance module 27 updates the invoices according to the return lists (step 922).

In the three-way trading, all of the three terminals are linked to the same transacting system. Thus, each of the three terminals can obtain relevant information efficiently and can further share information to one another, resulting in saved time and costs.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A transacting system for processing information in a three-way trading, the transacting system comprising:
a first terminal for loading order notices including order information into the transacting system, and the order notices including order quantity;
a second terminal for loading production lists including actual production information into the transacting system;
a third terminal for generating delivery confirmation receipts including information for confirming goods arriving and loading return merchandise authorizes into the transacting system; and
a server being connected to the first terminal, the second terminal, and the third terminal via networks, and the server comprising:
an ordering module for receiving the order notices and generating order lists including a predetermined format for being saved in the transacting system;
a shipping module for generating shipping notices including shipping information; and an invoice module for receiving the delivery confirmation receipts and generating invoices including transaction information according to the order notices and the shipping notices.

2. The transacting system according to claim 1, wherein the server comprises a production module for generating production schedules including production planning information.

3. The transacting system according to claim 2, wherein the server comprises an inventory module for generating inventory lists including inventory information, and the inventory lists comprise in-stock quantity information.

4. The transacting system according to claim 3, wherein the shipping module is further configured for judging whether the in-stock quantity is greater than or equal to the order quantity.

5. The transacting system according to claim 4, wherein the transacting system comprises a connecting apparatus for connecting the database to the server.

6. The transacting system according to claim 5, wherein the server comprises a maintenance module for searching, updating information in the database, and adding information to and deleting information from the database.

7. The transacting system according to claim 5, wherein the connecting apparatus is a java database connectivity.

8. The transacting system according to claim 1, wherein the network connecting the first terminal to the server is the internet, and the network connecting the second terminal and the third terminal to the server is an intranet.

9. A transacting method for processing information in a three-way trading, the transacting method comprising steps of:
loading order notices from a first terminal, the order notices including order quantity;
receiving the order notices and generating order lists via an ordering module;
loading production lists from a second terminal;
receiving the production lists and generating inventory lists via an inventory module, the inventory lists including in-stock quantity information;
judging whether the in-stock quantity is smaller than the order quantity via a shipping module;
generating shipping notices via the shipping module if the in-stock quantity is not smaller than the order quantity;
reading the shipping notices and generating delivery confirmation receipts via a third terminal;
receiving the delivery confirmation receipts and generating invoices via an invoice module.

10. The transacting method according to claim 8, wherein the transacting method further comprising a step of:
generating production schedules via a production module.

11. The transacting method according to claim 9, wherein the transacting method further comprising a step of:
going back to “the loading step” if the in-stock quantity is smaller than the order quantity.

12. The transacting method according to claim 10, wherein the transacting method further comprising steps of:
loading return merchandise authorizes from the third terminal;
receiving the return merchandise authorizes and generating return lists via the customer service module;
updating the invoices via the maintenance module.

13. The transacting method according to claim 8, wherein the invoices include goods names, total quantity, shipping dates, client names, goods values, transport costs, taxes, and sum values.
